(19) United States
(12) Patent Application Publication
(10) Pub. No.: US 2004/0172318 A1
(43) Pub. Date: Sep. 2, 2004

(54) System and method for capital depreciation simulation

(76) Inventor: Fong Shen, Miao-Li City (TW)

Correspondence Address: SLATER & MATSIL, L.L.P., 17950 PRESTON RD, SUITE 1000, DALLAS, TX, 75252-5793, US

(21) Appl. No.: 10/375,598

(22) Filed: Feb. 27, 2003

(51) Int. Cl. G06F 17/60

(52) U.S. Cl. 705/7

(57) ABSTRACT

System and method for a dynamic multiple condition/multiple version simulation model for fixed asset depreciation. The simulation model may be used in or interfaced directly with the enterprise resource planning system, and the data may be manipulated directly in the enterprise resource planning system database itself. The system and method increase the accuracy of capital depreciation forecasts, shorten the capital depreciation forecast cycle time, and reduce manpower for the forecast process.

### TECHNICAL FIELD

The present invention relates generally to a system and method for simulation of capital depreciation, and more particularly to a system and method for multiple condition/multiple version simulation of capital depreciation.

### BACKGROUND

In a capital-intensive company, capital or fixed asset (FA) depreciation may be the most influential factor affecting corporate financial management. For example, in the semiconductor industry, FA depreciation may account for over half of the annual operating expenses of a company, due to the extremely high cost of modem day semiconductor fabrication facilities. Generally, control of FA acquisition/depreciation is important because it directly impacts and corporate management's decision making and the corporation's performance (e.g., earnings per share, break-even determination, etc.). Therefore, simulation of FA depreciation can be of significant value to a company's executives and division/department managers for assisting in the prediction of future capital expenses.

In the prior art, however, it has been difficult to use FA depreciation simulation in designing an optimal FA acquisition/depreciation plan. While enterprise resource planning (ERP) systems (e.g., SAP and ORACLE), have been used by industry for several years, they generally do not provide a simulation model for FA depreciation. ERP systems may consolidate many of an enterprise's functions and departments, such as accounting, manufacturing, sales and human resources, into one management system. An ERP system may provide an integrated software program implemented on a computer system that uses a single database stored on a computer-readable medium. The ERP system may allow the various enterprise functions to share information and communicate with each other. Thus, while ERP systems generally provide many useful functions, the simulation of FA depreciation is not one of them.

One method used in the prior art in an attempt to circumvent this deficiency is for a user to download raw data from an ERP system database to a file on a separate computer (e.g., personal computer). The user may then tune parameters in the file to simulate different depreciation situations. This process is not simple or efficient for the user because there can be a very large amount of data in the ERP system database. For example, in the semiconductor industry, a large company may have tens or hundreds of thousands of capital assets, with all their pertinent information stored in the ERP system database.

In addition, if a user finds that the downloaded master data is wrong, or that the master data has been updated in the ERP database, then the user needs to download the raw data again. Also, the user then needs to modify the raw data for the various depreciation simulations all over again. In other words, the entire simulation generally has to be rebuilt in a new table. Of course, this process can be very inefficient and time-consuming. Moreover, there is no mechanism for version control of the data, or for comparing different versions with each other. Because of these reasons, FA depreciation simulation cannot be used to its full potential in prior art enterprise planning.

### SUMMARY OF THE INVENTION

These and other problems are generally solved or circumvented, and technical advantages are generally achieved, by preferred embodiments of the present invention which provide a dynamic multiple condition/multiple version simulation model for fixed asset depreciation. The simulation model may be used in or interfaced directly with the enterprise resource planning system, and the data may be manipulated directly in the enterprise resource planning system database itself.

In accordance with a preferred embodiment of the present invention, a method for simulating fixed asset depreciation in an enterprise resource planning system comprises storing a first set of condition data for a first fixed asset type in a database of the enterprise resource planning system, storing a second set of condition data for the first fixed asset type in the database, wherein the second set of condition data is different from the first set, storing a third set of condition data for a second fixed asset type in the database, combining the first and third sets of condition data into a first plan version, executing a first depreciation simulation using the first plan version, and compiling results from the first depreciation simulation into a simulation report.

In accordance with another preferred embodiment of the present invention, a system for simulating fixed asset depreciation comprises an enterprise resource planning system database containing information for fixed assets of an enterprise, said fixed assets grouped into multiple fixed asset types, multiple sets of fixed asset conditions stored in said database, each one of said sets comprising depreciation related parameters for one of said multiple fixed asset types, a multiple condition control module, said condition control module for modifying said parameters in said multiple sets of fixed asset conditions, a multiple plan version control module, said version control module for generating multiple plan versions, each one of said plan versions containing one of said sets of conditions for each of said fixed asset types, and a simulation engine, said engine for executing depreciation aggregation simulation for a selected one of said plan versions.

Advantages of preferred embodiments of the present invention include an increase in the accuracy of capital depreciation forecasts, the shortening of the capital depreciation forecast cycle time, and the reduction of manpower for the forecast process.

Another advantage of a preferred embodiment of the present invention is the capability of providing of simulations under different financial assumption combinations.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram showing a typical prior art depreciation planning implementation;

FIG. 2 is a block diagram of a preferred embodiment depreciation simulation implementation;

FIG. 3 is a block diagram illustrating multiple condition/multiple version control in accordance with a preferred embodiment of the present invention;

FIG. 4 is a diagram of an input screen for simulation condition control;

FIG. 5 is a diagram of a condition control menu screen;

FIG. 6 is a diagram of an input screen for condition version creation;

FIGS. 7-10 are diagrams of screens illustrating various simulation condition data;

FIGS. 11 and 12 are diagrams of screens showing various depreciation plan results; and

FIG. 13 is a diagram of a screen illustrating a simulation comparison.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely implementation in an SAP system. The invention may also be applied, however, to other enterprise integration systems or enterprise resource planning systems, such as ORACLE and ERP II systems.

With reference now to FIG. 1, there is shown a typical prior art depreciation planning implementation utilizing data from an enterprise resource planning (ERP) system. ERP system 100 includes a database containing raw data providing information about various aspects of the enterprise's departments and functions. With respect to the components most relevant to capital depreciation simulation, the database includes open purchase request (PR) data 102, open purchase order (PO) data 104, open goods received/invoices received (GR/IR or GI) data 106, and fixed asset (FA) data 108.

Because the ERP system 100 does not provide FA depreciation simulation, a user downloads raw data for processing from ERP system 100 to local spreadsheet file or database 110, which is separate from the ERP system database. The amount of data that is downloaded can be quite large, depending on the number of fixed assets described in the database. To simulate different depreciation situations, the user must modify the parameters in local database 110, changing the data downloaded from ERP system 100.

The user may modify a variety of parameters in the downloaded data. Once the user is satisfied with the modifications, the user manually triggers a FA depreciation aggregation for the desired future time period (e.g., the next quarter or the next year) to generate depreciation simulation report 112.

When data is subsequently updated on ERP system 100, however, the data in local database 110 becomes out of date, and the data generally grows increasingly stale as more time elapses since the data download. Once new data is downloaded, the user will need to re-modify the raw data for the various depreciation simulations. In addition, there is no mechanism for version control of the data; the user may modify some raw data, and may not be able to recover the original raw data. Moreover, there is no mechanism for comparing different versions of simulated depreciation data with each other.

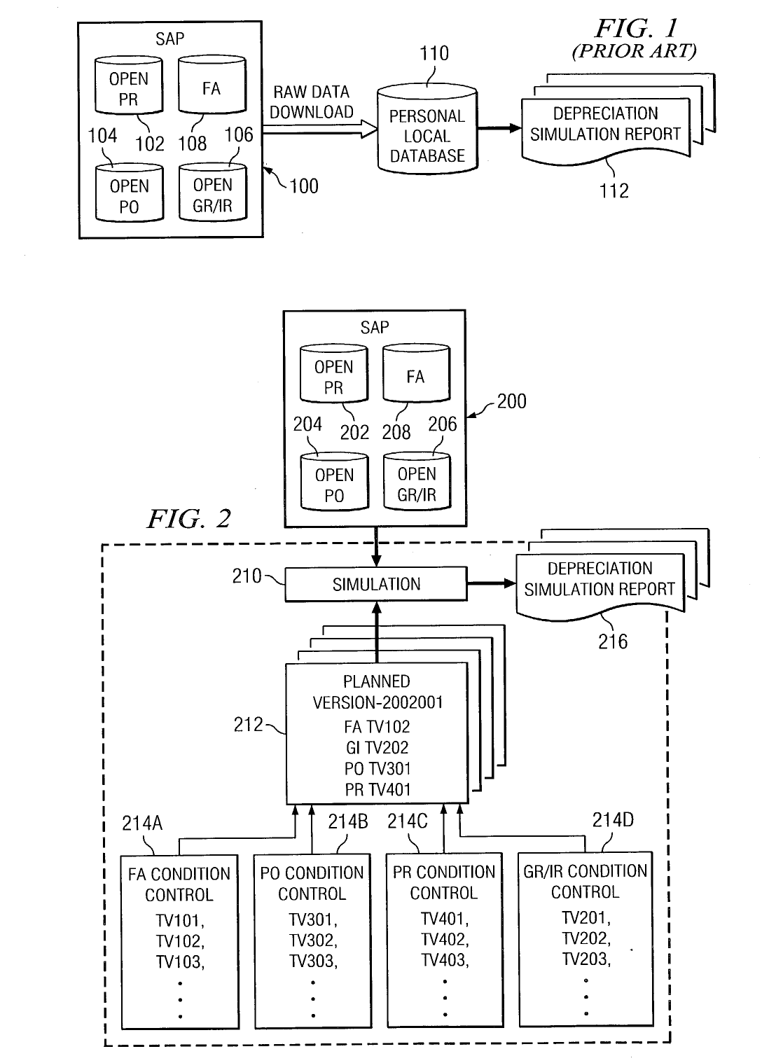

With reference now to FIG. 2, there is shown a block diagram of a preferred embodiment depreciation simulation model implemented in an ERP system. The simulation uses dynamic multiple condition/multiple version control for modeling FA depreciation. This dynamic control provides the user with the flexibility to easily change simulation parameters, keep track of simulation versions, and to compare different simulations with each other.

ERP system 200 includes a database containing raw data providing information about various aspects of the enterprise's departments and functions. With respect to the components most relevant to capital depreciation simulation, the database includes open purchase request (PR) data 202, open purchase order (PO) data 204, open goods received/invoices received (GR/IR) data 206, and fixed asset (FA) data 208. The database may also include relevant budget balance and insurance information, as well as any other data affecting fixed asset depreciation. PR data 202 contains information on open internal purchase requests issued to the purchase department, while PO data 204 contains information on open external purchase orders to external vendors. The information used in GR/IR data 206 is the open capital GR/IR, that is, the information relating to capital objects stored in GR/IR data 206. Finally, FA data 208 provides data on the enterprises physical fixed assets. The simulation may use all or part of this ERP system data to define and depreciate the capital of the enterprise.

The simulation model may be built directly in the ERP system, and may manipulate data directly in the ERP system. The simulation model comprises three primary components, simulation engine 210, multiple version control 212, and multiple condition control 214A-D.

The user may use the condition control to create or modify a variety of transaction or condition parameters, including cost center (transfer in, transfer out), acquisition mount (retirement), depreciation amount (retirement), key machine (K/M) code (transfer), and others. The KIM code identifies equipment for different functions and locations. All parameters relative to a specific capital data type for a given scenario may be saved in the database as a specific condition for that data type. For example, FA condition control 214A lists three different saved conditions, TV101, TV102 and TV103. Each of these conditions has a different set of parameters saved representing a different fixed asset scenario. Likewise, PO condition control 214B lists three different saved conditions for open capital purchase orders, TV301, TV302, and TV303; PR condition control 214C lists three different saved conditions for open capital purchase requests, TV401, TV402, and TV403; and GR/IR condition control 214D lists three different saved conditions for open capital goods received/invoices received, TV201, TV202, and TV203.

After the user has created one or more saved conditions for each of the different capital data types, the user may combine different conditions into one or more planned versions in planned version control 212. Each planned version may contain a different combination of conditions. As shown in FIG. 2, planned version 2002001 contains FA condition TV102, GI condition TV202, PO condition TV301, and PR condition TV401. In this way, the user may easily combine different conditions into a unique planned version, and may quickly change that version or create a new version simply by using a different condition from one or more of the four capital data types.

Once the user has created various conditions using condition control 214A-D and created one or more planned versions using version control 212, the user may use simulation engine 210 to run a FA depreciation aggregation for a desired future time period (e.g., the next quarter or the next year) to generate depreciation simulation report 216.

The simulation engine comprises a depreciation rule control module, a depreciation aggregation simulation module, and a simulation report module. The depreciation rule control module is adjustable and allows the user to change depreciation rules for different simulations. The aggregation simulation module receives selected version and condition data from the version control and condition control functions, and receives depreciation rules from the depreciation rule control module. The depreciation rules are applied to the capital data by the aggregation simulation module to derive a depreciation plan for the selected time period. Finally, the simulation report module generates the requested report in the format specified by the user.

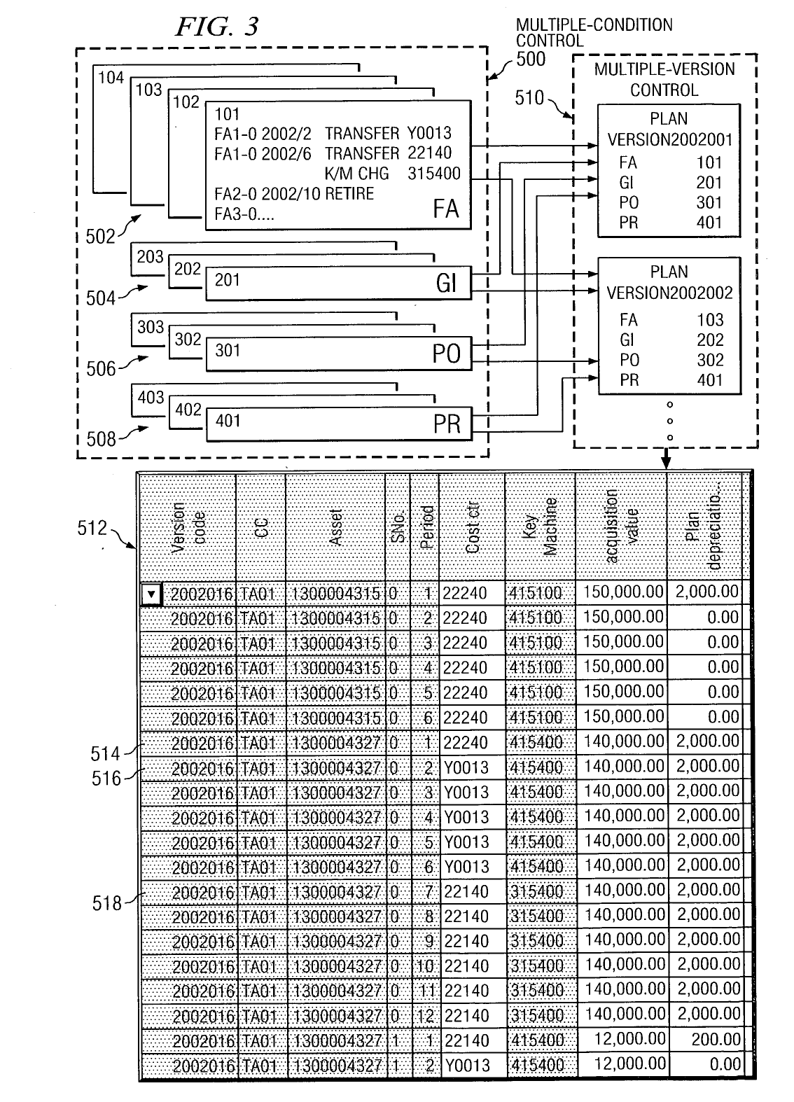

With reference now to FIG. 3, there is shown a block diagram illustrating an example of multiple condition/multiple version control. Multiple condition control 500 contains multiple conditions related to depreciation for different categories of capital assets. In this example, FA condition control 502 contains four condition parameter variations, FA101, FA102, FA103 and FA104. In particular, FA101 contains one set of parameters or transactions for various fixed assets of the enterprise. The first FA1-0 entry indicates a transfer of asset 1300004327 from cost center 22240 to cost center Y0013 in month 2. The second FA1-0 entry indicates a transfer of asset 1300004327 from cost center Y0013 to cost center 221240 in month 6, and a key machine code transfer from 415400 to 315400 in month 6.

Likewise, GI condition control 504 contains three condition parameter variations, G1201, G1202 and G1203, for goods received/invoices received; PO condition control 506 contains three condition parameter variations, P0301, P0302 and P0303 for purchase orders; AND PR condition control 508 contains three condition parameter variations, PR401, PR402 and PR403 for purchase requests. Various combinations of these multiple conditions are compiled into plan versions for depreciation simulation by multiple version control 510, of which two examples are shown in FIG. 3. In particular, multiple version control 510 combines FA101, GI 201, P0301 and PR401 into plan version 200201 for input into the simulation engine. Plan version 2002002 is a different plan version that still uses PR401, but uses different conditions, FA103, GI202 and PO302, for the other three capital categories. By running simulations on plan versions 2002001 and 2002002, the user may compare the effect on FA depreciation of changes in capital planning, reflected in the selected plan versions and selected condition parameters.

Plan depreciation table 512 in FIG. 3 illustrates the results of executing a depreciation simulation using the FA 101 entries described above. Assuming plan version 2002016 uses condition FA101, the table illustrates monthly depreciation for asset 1300004327. In the first month 514, the asset is in cost center 22240, and has a key machine code of 415400 and an acquisition value of $140,000.

In the second month 516, the asset is transferred to cost center Y00113 per the conditions set in FA101. Monthly depreciation for the asset is $2,000. This repeats until the seventh month, where the asset is transferred to cost center 22140 and the key machine code is transferred to 315400. Depreciation remains the same at $2,000 per month. If the user wishes to run a new simulation applying different conditions to this asset, then the user simply incorporates a different FA condition, listing a different treatment for the asset, into a new plan version.

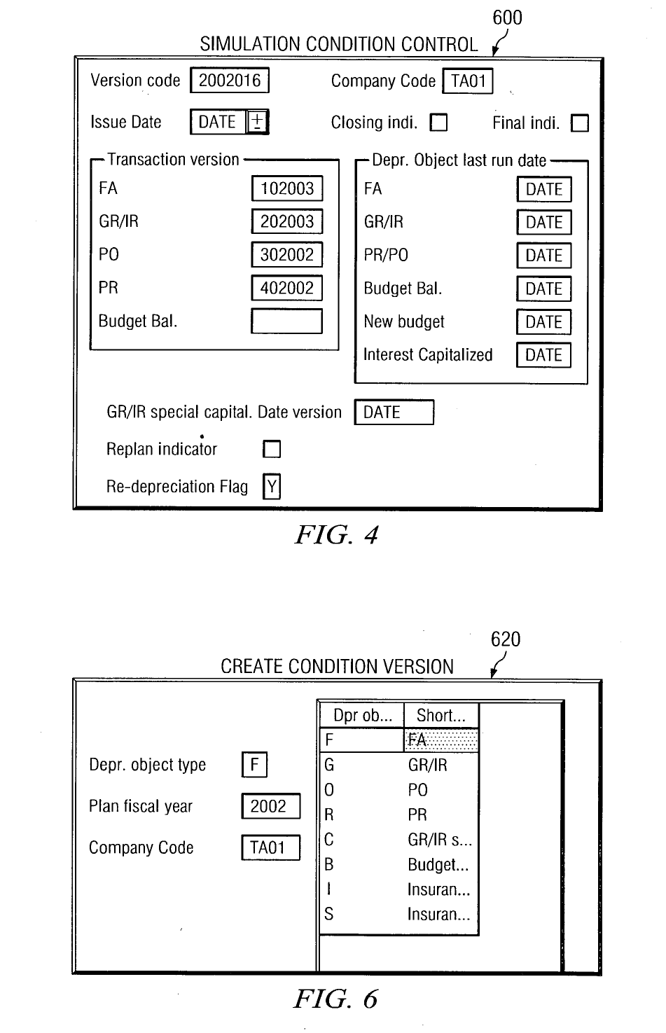

With reference now to FIG. 4, there is shown input screen 600 for simulation condition control. In this screen, the user selects the specific condition parameter versions for a plan version. In this case, the user has selected transaction versions FA102003, GI202003, PO302002 and PR 402002 for plan version 2002016. The screen also indicates the date on which the depreciation object was last run for the various condition parameters.

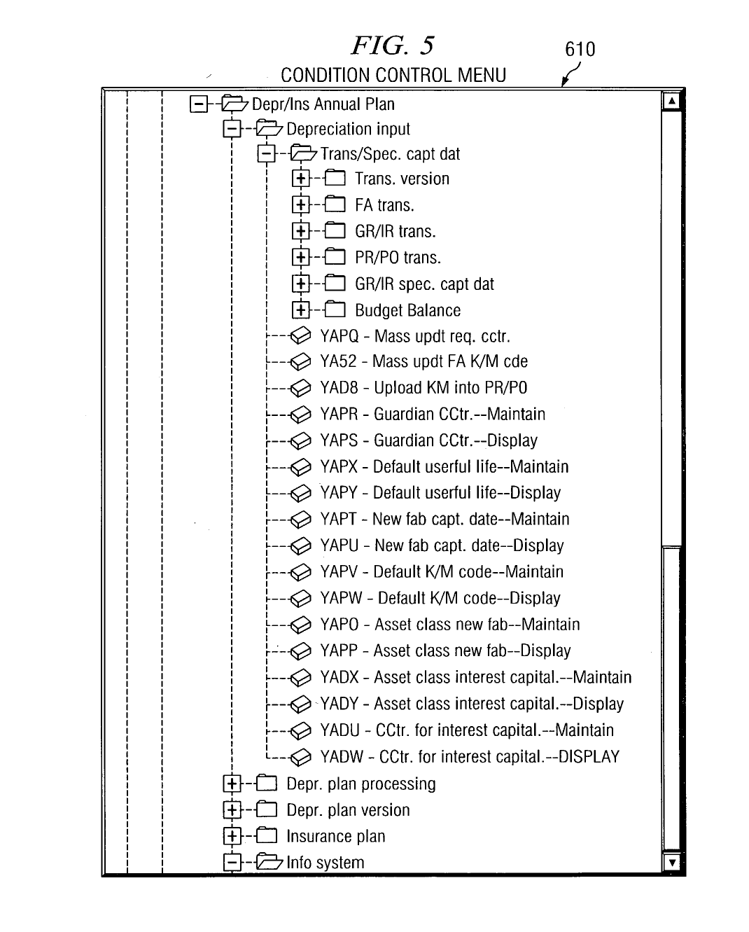

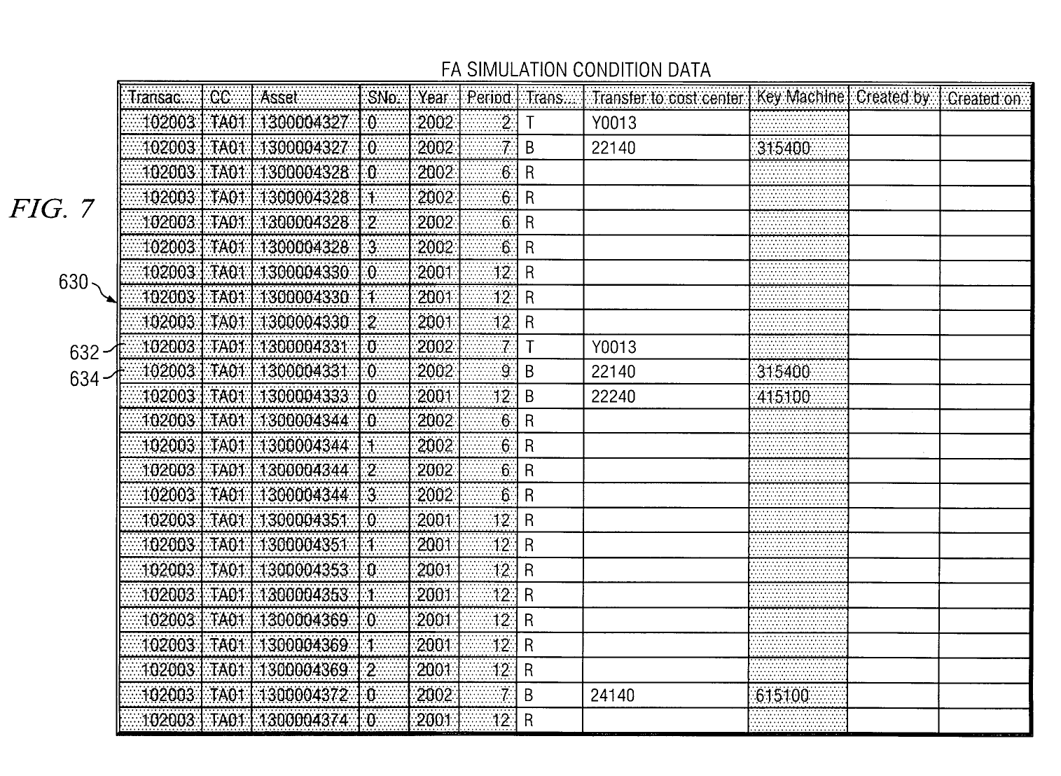

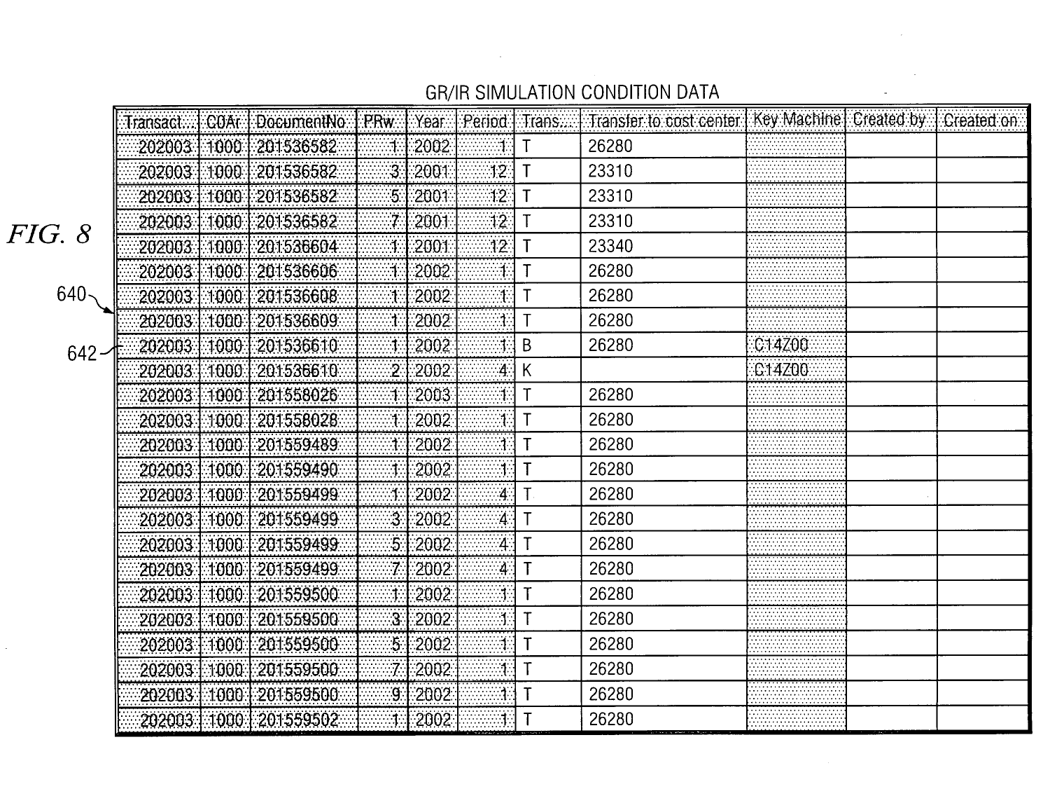

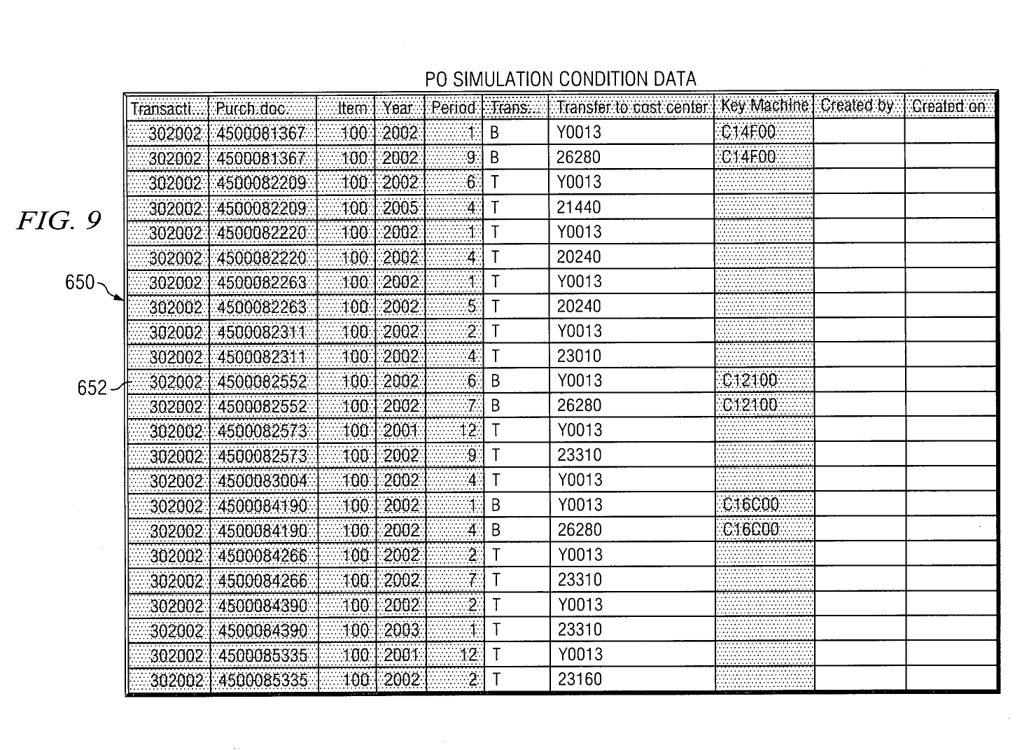

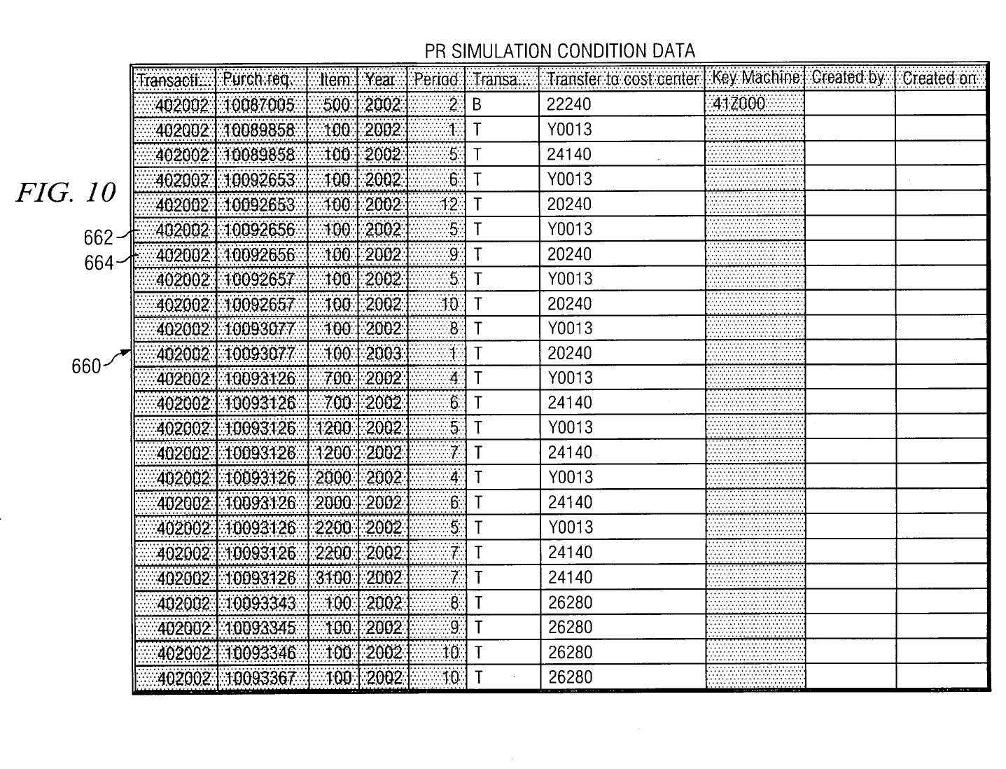

With reference now to FIG. 5, there is shown condition control menu screen 610. From this menu the user may select a variety of input or informational screens relating to depreciation simulation, several of which are described in more detail below. For example, FIG. 6 illustrates condition version creation input screen 620. With this input screen the user may select a depreciation object type and the plan fiscal year for the depreciation object. FIGS. 7-10 illustrate various screens of simulation condition data. FIG. 7 contains FA simulation control data table 630; FIG. 8 contains GI simulation control data table 640; FIG. 9 contains PO simulation control data table 650; and FIG. 10 contains PR simulation control data table 660.

In FIG. 7, table 630 contains the condition data for FA condition 102003. In this table, the user has defined the transactions that will affect various assets in the fixed asset category type. For example, asset 1300004331 has two transactions affecting it in this condition data set. In entry line 632, the asset is transferred to cost center Y0013 in the 7^{th} month of 2002. In the 9^{th} month of 2002, the asset is again transferred, this time to cost center 22140. In addition, the asset is assigned a new key machine code of 315400.

Similarly, in FIG. 8, table 640 contains the condition data for GI condition 202003. In this table, the user has defined the transactions that will affect various assets in the goods received/invoices received category type. For example, in entry line 642, the asset associated with document 201536610 is transferred to cost center 26280 in the 1^{st} month of 2002. In addition, the asset is assigned a key machine code of C14Z00.

In FIG. 9, table 650 contains the condition data for PO condition 302002. In this table, the user has defined the transactions that will affect various assets in the purchase order category type. For example, in entry line 652, the asset associated with purchase document 4500082552 is transferred to cost center Y0013 in the 6^{th} month of 2002, and is assigned a key machine code of C12100.

In FIG. 10, table 660 contains the condition data for PR condition 402002. In this table, the user has defined the transactions that will affect various assets in the purchase request category type. For example, in entry line 662, the asset associated with purchase request 10092657 is transferred to cost center Y0013 in the 5^{th} month of 2002. In entry line 664, the asset is transferred to cost center 20240 in the 9^{th} month of 2002.

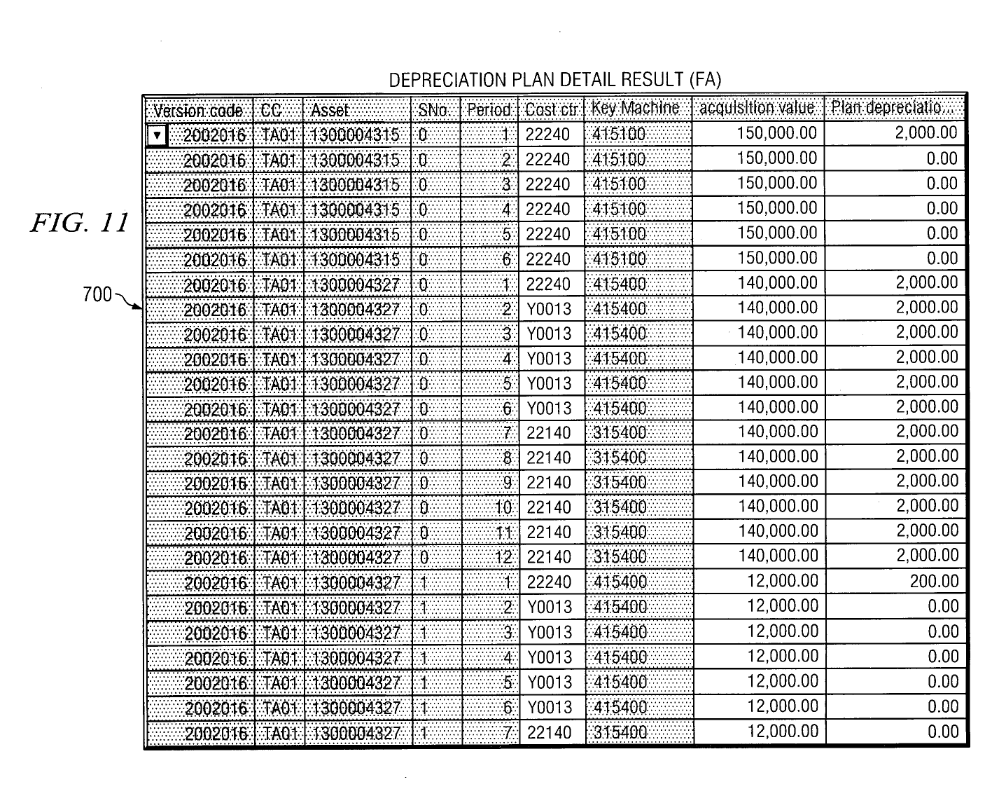

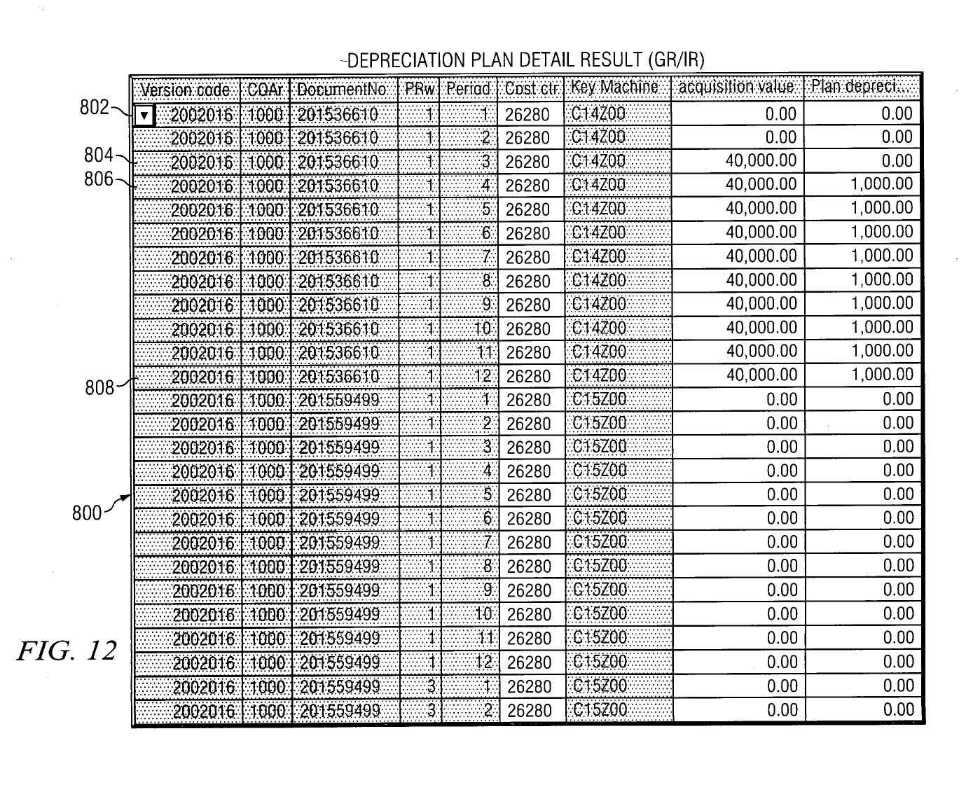

With reference now to FIGS. 11 and 12, there are shown reports containing depreciation plan results obtained from executing a depreciation simulation using plan version 2002016. In FIG. 11, simulation results are displayed in table 700 for the fixed asset category; these results previously have been described in the discussion of FIG. 3. As for FIG. 12, simulation results are displayed in table 800 for the goods received/invoices received category. For the asset represented by document number 201536610, depreciation results are shown for each month in 2002. The asset is assigned to cost center 26208 and key machine code c14Z00 in the 1^{st}month in line 802. The asset is acquired in the 3^{rd} month for $40,000 in entry line 804. $1,000 of depreciation is taken starting with the 4^{th} month in line 806, and continues for the same amount each month through the 12^{th} month in line 808.

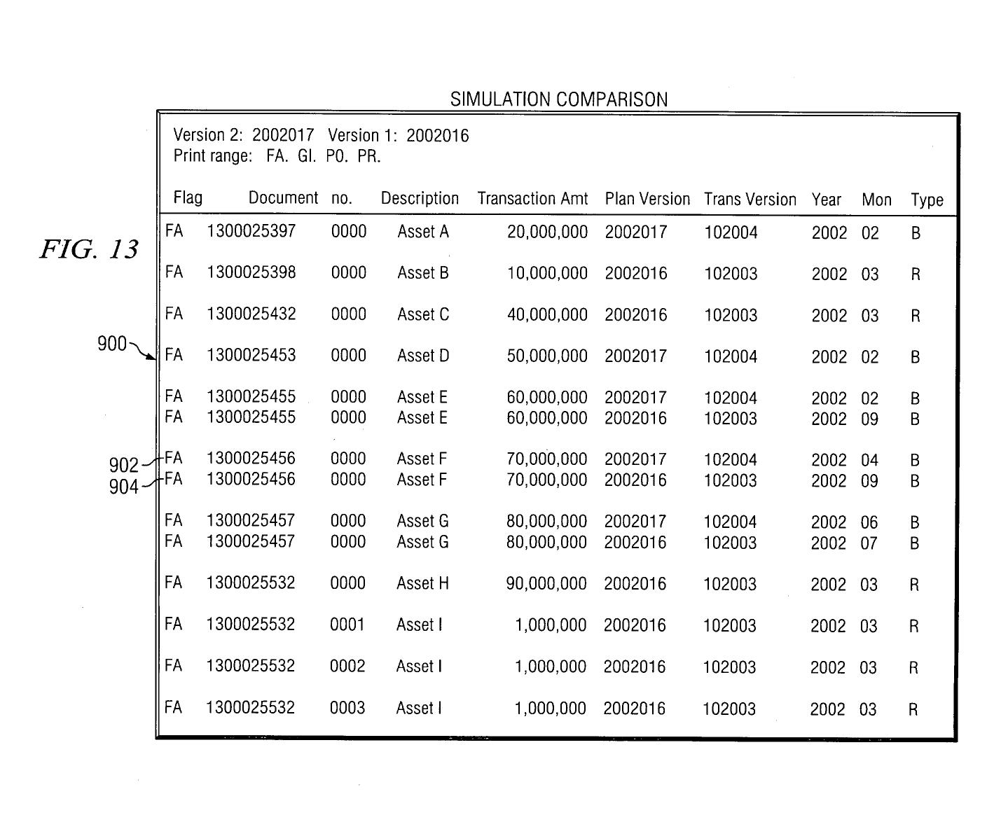

With reference now to FIG. 13, there is shown simulation comparison report 900. In this report, the simulation results for two plan versions 2002016 and 2002017, each containing different condition data, are compared to each other. For example, lines 902 and 904 show data relevant to asset F. Line 902 shows data for plan version 2002017, and line 904 shows data for plan version 2002016. Plan version 2002017 uses FA102004 condition or transaction version, and plan version 2002016 uses FA102003 transaction version. Transaction version 102004 indicates that a transaction for asset F occurs in the 4^{th} month of 2002, while transaction version 102003 indicates that a transaction for asset F occurs in the 9^{th} month of 2002. The simulations may thus be compared to determine the effect of the different transactions on simulated fixed asset depreciation.

In a preferred embodiment, the data used in the simulations correlates accurately to the ERP system database because the data manipulated directly in the ERP system database. Therefore, forecast accuracy is significantly increased (e.g., from about 40% up to near 100%). In addition, the user may save versions of the different condition versions and plan versions, and the user does not need to update data on a different system. Therefore, forecast cycle time and manpower are also significantly reduced (e.g., from about 8 man-days down to about one-half a man-day). The user may also compare simulation results in a way not previously available with prior art systems.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that the quantity and type of input transactions and data types, the format and content of tables, and the organization of the functional modules may be varied while remaining within the scope of the present invention. In addition, the disclosed methods and systems may be used to simulate other variables requiring forecasting by an enterprise. Preferred embodiments may be implemented on a single computer system or on a distributed computer system providing access to a common database for the enterprise resource system. As an alternative, a user may generate or execute only a partial fixed asset depreciation simulation, and therefore may only utilize some of the fixed asset information stored in the system database. The simulation report may be provided to the user in many different formats, including textual, tabular, and graphical formats, and may be shown on a screen, printed, or stored on a computer-readable medium.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of simulating fixed asset depreciation in an enterprise resource planning system, said method comprising:
storing a first set of condition data for a first fixed asset type in a database of said enterprise resource planning system;
storing a second set of condition data for said first fixed asset type in said database, wherein said second set of condition data is different from said first set;
storing a third set of condition data for a second fixed asset type in said database;
combining said first and third sets of condition data into a first plan version;
executing a first depreciation simulation using said first plan version; and
compiling results from said first depreciation simulation into a simulation report.

2. The method of claim 1, further comprising:
storing a fourth set of condition data for a third fixed asset type in said database;
storing a fifth set of condition data for a fourth fixed asset type in said database; and
combining said fourth and fifth sets of condition data into said first plan version,
wherein said first asset type is physical fixed assets, said second asset type is open capital purchase orders, said third asset type is open capital purchase requests, and said fourth asset type is open capital goods and invoices received.

3. The method of claim 2, wherein multiple sets of condition data for each of said first, second, third and fourth fixed asset types are stored in said database.

4. The method of claim 3, further comprising generating multiple plan versions, each one of said multiple plan versions containing a different combination of said first, second, third and fourth asset type condition data.

5. The method of claim 1, further comprising:
combining said second and third sets of condition data into a second plan version;
executing a second depreciation simulation using said second plan version; and
compiling results from said second depreciation simulation into a simulation report.

6. The method of claim 5, further comprising generating a comparison report comparing said first and second depreciation simulations.

7. The method of claim 1, further comprising modifying parameter values in said first set of condition data.

8. The method of claim 1, further comprising modifying said first plan version to contain said second set of condition data instead of said first set of condition data.

9. The method of claim 1, wherein said sets of condition data contain information related to asset transfers in and out of cost centers, key machine code transfers, and asset retirement.

10. A system for simulating fixed asset depreciation, said system comprising:
an enterprise resource planning system database containing information for fixed assets of an enterprise, said fixed assets grouped into multiple fixed asset types;
multiple sets of fixed asset conditions stored in said database, each one of said sets comprising depreciation related parameters for one of said multiple fixed asset types;
a multiple condition control module, said condition control module for modifying said parameters in said multiple sets of fixed asset conditions;
a multiple plan version control module, said version control module for generating multiple plan versions, each one of said plan versions containing one of said sets of conditions for each of said fixed asset types; and
a simulation engine, said engine for executing depreciation aggregation simulation for a selected one of said plan versions.

11. The system of claim 10, wherein said simulation engine comprises:
a depreciation rule control module;
a depreciation aggregation simulation module; and
a simulation report module.

12. The system of claim 11, wherein said depreciation rule control module provides adjustable depreciation rules for simulations executed by said depreciation aggregation simulation module, and wherein said depreciation simulation aggregation module provides simulation results to said simulation report module for generating simulation reports.

13. The system of claim 12, wherein said simulation report module further generates a comparison report comparing depreciation simulations for different said plan versions.

14. The system of claim 10, wherein said multiple fixed asset types comprise physical fixed assets, open capital purchase orders, open capital purchase requests, and open capital goods and invoices received.

15. The system claim 10, wherein said multiple plan versions each comprise a different set of fixed asset conditions.

16. The system of claim 10, wherein said depreciation related parameters comprise asset transfers in and out of cost centers, key machine code transfers, and asset retirement.

17. A computer-readable medium having computer code recorded thereon executable by a computer, said computer code comprising:
instructions for storing a first set of condition data for a first fixed asset type in an enterprise resource planning system database;
instructions for storing a second set of condition data for said first fixed asset type in said database, wherein said second set of condition data is different from said first set;
instructions for storing a third set of condition data for a second fixed asset type in said database;
instructions for combining said first and third sets of condition data into a first plan version;
instructions for executing a first depreciation simulation using said first plan version; and
instructions for compiling results from said first depreciation simulation into a simulation report.

18. The computer-readable medium of claim 17, further comprising:
instructions for storing a fourth set of condition data for a third fixed asset type in said database;
instructions for storing a fifth set of condition data for a fourth fixed asset type in said database; and
instructions for combining said fourth and fifth sets of condition data into said first plan version,
wherein said first asset type is physical fixed assets, said second asset type is open capital purchase orders, said third asset type is open capital purchase requests, and said fourth asset type is open capital goods and invoices received.

19. The computer-readable medium of claim 17, further comprising:
instructions for combining said second and third sets of condition data into a second plan version;
instructions for executing a second depreciation simulation using said second plan version; and
instructions for compiling results from said second depreciation simulation into a simulation report.

20. The computer-readable medium of claim 19, further comprising instructions for generating a comparison report comparing said first and second depreciation simulations.
